(19) United States
(12) Patent Application Publication
(10) Pub. No.: US 2002/0110682 A1
(43) Pub. Date: Aug. 15, 2002

(54) Non-skid coating and method of forming the same

(76) Inventor: Jeffrey A. Brogan, Port Jefferson, NY (US)

Correspondence Address: MARK KUSNER COMPANY LPA, HIGHLAND PLACE SUITE 310, 6151 WILSON MILLS ROAD, HIGHLAND HEIGHTS, OH, 44143

(21) Appl. No.: 10/016,458

(22) Filed: Dec. 10, 2001

Related U.S. Application Data
(60) Provisional application No. 60/254,855, filed on Dec. 12, 2000.

(51) Int. Cl. B05D 1/02; B32B 27/06

(52) U.S. Cl. 428/325; 427/447; 427/453; 427/140; 428/480

(57) ABSTRACT

A thermally-sprayed non-skid coating that is comprised of an aggregate material embedded within a layer which is comprised of at least one coalesced, thermoplastic polymer. The aggregate has a melting temperature greater than the melting temperature of the at least one coalesced, thermoplastic polymer, and the coating contains no volatile, organic compounds.

### FIELD OF THE INVENTION

The present invention relates to non-skid coatings and methods of forming the same, and more particularly, to a non-skid, polymeric-based coating applied to surfaces by a thermal spraying process.

### BACKGROUND OF THE INVENTION

Non-skid surfaces are used in many residential, commercial and military applications to increase friction and traction. For example, a non-skid coating finds advantageous application on exterior stairs, walkways and work areas in residential and commercial establishments. In the military, non-skid coatings are used on weather decks, hanger decks and flight decks of naval vessels, as well as on interior surfaces of amphibious vessels and aircraft.

In these and other such applications, a main purpose of a non-skid coating is to increase traction and friction when both dry and wet. However, such surfaces typically must also meet other requirements, such as good fire resistance, good resistance to chemicals and the environment, good impact resistance, low toxicity and good adhesion to an underlying substrate.

It is known to form polymer-based, non-skid coatings using liquid-based epoxy, polyurethane or alkyd systems. Such liquid-based systems are typically comprised of a volatile liquid component containing dispersed polymer droplets and friction-contributing additives, such as metal, ceramic or polymeric particulates. These liquid-based, non-skid coatings typically require that the underlying surface be prepared using an organic primer. Liquid-based, non-skid coatings undergo a cure cycle, wherein the molecular weight of the polymer chain increases, thus enhancing the polymer physical properties. In this respect, liquid-based coatings are typically amorphous as significant “branching” may occur during the cure cycle.

One problem with conventional, liquid-based, non-skid coatings is that they contain volatile organic compounds (VOC's) that are harmful to the environment and individuals. Another problem with such liquid-based systems is that they are difficult to repair or replace. To replace a non-skid coating requires that the original coating be removed from the underlying surface. Processes currently employed to remove a degraded liquid-based non-skid coating include abrasive blasting or removal by high-pressure water. Such processes are not only time-consuming, but are also expensive, and represents a health hazard due to the creation of air borne particulate, i.e., the friction-contributing additive. Further, if the surface to be repaired is near machinery, such equipment must be protected, to prevent air borne particulate from coming into contact therewith and causing damage thereto.

The present invention overcomes these and other problems associated with conventional, liquid-based non-skid systems and provides a non-skid coating that is simple to apply and repair, that contains no VOC's, and has no long cure time after application.

### SUMMARY OF THE INVENTION

In accordance with a preferred embodiment of the present invention, there is provided a non-skid structure comprised of a support substrate and a non-skid coating which is adhered to the substrate. The non-skid coating is comprised of an aggregate material embedded in a layer comprised of at least one coalesced, thermoplastic polymer.

In accordance with another embodiment of the present invention, there is provided a method of forming a non-skid surface that comprises the steps of: mixing a thermoplastic polymer in particulate form with an aggregate in particulate form; and thermally spraying a mixture of the polymer particulate and the aggregate onto a clean surface, such that the polymer particulate coalesces on the surface into a continuous layer of polymer with the aggregate embedded therein.

In accordance with another embodiment of the present invention, there is provided a non-skid coating that is comprised of an aggregate material embedded within a layer which is comprised of at least one coalesced, thermoplastic polymer. The aggregate has a melting temperature greater than the melting temperature of the at least one coalesced, thermoplastic polymer, and the coating contains no volatile, organic compounds.

In accordance with yet another embodiment of the present invention, there is provided a method of repairing a non-skid coating that is comprised of an aggregate embedded in a layer which is comprised of at least one thermoplastic polymer. The method comprises the steps of heating the non-skid coating until the outer surface thereof begins to melt; and thermally spraying a mixture of the aggregate and a polymer containing the at least one thermoplastic polymer onto the outer surface of the coating.

In accordance with another aspect of the present invention, there is provided a coating mix for forming a non-skid coating by a thermal spraying process. The coating mix has a polymer powder comprised of at least one thermoplastic polymer powder, and an aggregate powder. The aggregate powder is formed from a material selected from the group consisting of glass, ceramic, metal, polymer, elastomer and combinations thereof. The coating mix contains no volatile organic compounds.

It is an object of the present invention to provide a non-skid coating for a support surface.

It is another object of the present invention to provide a non-skid coating for use on a wide variety of materials, such as by way of example and not limitation, metal, wood, stone, plastic, polymer, elastomer or concrete.

It is another object of the present invention to provide a non-skid coating as described above that is comprised of a composite coating that adheres to a wide variety of materials.

It is another object of the present invention to provide a non-skid coating as described above that may be applied directly onto a support surface without the need for a primer material on the surface.

A still further object of the present invention is to provide a non-skid coating as described above that has good chemical and environmental resistance.

A still further object of the present invention is to provide a non-skid coating as described above that does not contain volatile organic compounds (VOC's).

A still further object of the present invention is to provide a non-skid coating as described above that is easy to repair.

A still further object of the present invention is to provide a non-skid coating as described above that has no long cure or set-up time.

A still further object of the present invention is to provide a method of forming a non-skid coating on a support surface.

These and other objects will become apparent from the following description of a preferred embodiment taken together with the accompanying drawings and the appended claims.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1 is a partially schematic, partially pictorial view of a system and method of forming a non-skid surface according to the present invention;

FIG. 2 is an enlarged, cross-sectional view taken along lines 2-2 of FIG. 1;

FIG. 3 is a sectional view of a non-skid composite coating according to the present invention showing a portion thereof worn away; and

FIG. 4 is a sectional view of the portion of the non-skid composite coating shown in FIG. 3, showing such portion repaired according to another aspect of the present invention.

### DETAILED DESCRIPTION OF PREFERRED EMBODIMENT

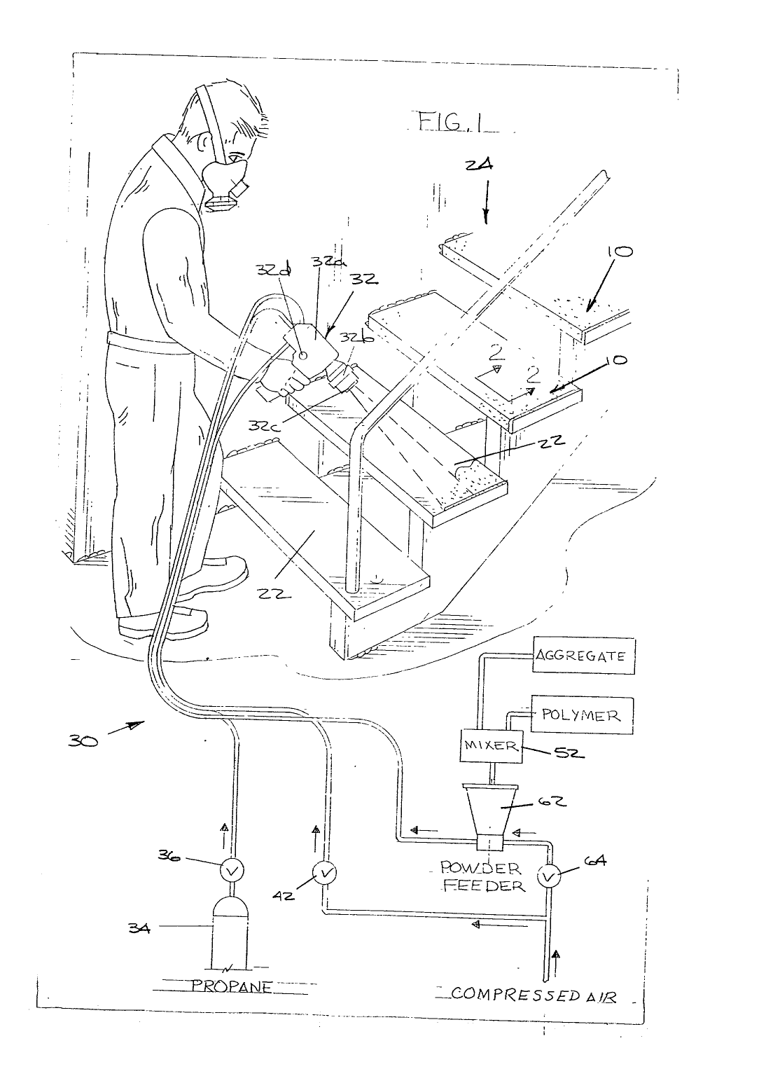

Referring now to the drawings wherein the showings are for the purpose of illustrating preferred embodiments of the invention only, and not for the purpose of limiting same, FIG. 1 is a pictorial view showing a non-skid coating 10 being applied to a surface by a thermospraying process. The present invention relates to non-skid, polymeric coating 10 and a method of applying the same to a three dimensional surface or structure or to a two dimensional surface.

In the embodiment shown, coating 10 is being applied to a stair tread 22 of a stairway 24. Coating 10 is comprised of a mixture containing a polymer or polymer blend and a reinforcing/friction-enhancing material in aggregate form.

The term “thermal spraying” encompasses a group of processes that includes flame spraying, high velocity Oxy-Fuel (HVOF) spraying, plasma spraying, detonation spraying and cold gas dynamic spraying. As used herein, thermal spraying is defined as a process of transporting a polymer and an aggregate in a gas stream such that the polymer has sufficient thermal and/or kinetic energy such that the polymer undergoes plastic deformation upon impact with a surface and bonds with the impacted surface with the aggregate embedded therein. In a preferred embodiment, the polymer and aggregate material are in particulate form. Flame spraying is a process in which a flame is used to soften the polymer or polymer particulate prior to spraying the polymer particulate in a gas stream. The polymer is softened by the flame, and sticks to a surface upon impact and ultimately coats the surface.

In the context of the present invention, the term “thermal spraying” is intended to include spraying of a polymer or polymer particulate with such velocity that its kinetic energy is sufficient to soften/melt the polymer or polymer particulate upon impact with a surface resulting in a coalesced coating of polymer on the surface. The term “thermal spraying” is also meant to encompass any known method of depositing an organic containing material, such as a polymer, onto a surface wherein the organic containing material is heated above the ambient temperature to a point where it softens and/or melts so that is may be deposited on a surface by a stream of propelling gas impinging on the organic containing material.

FIG. 1 shows a thermal spraying device 30 for applying non-skid coating 10 onto a surface. Thermal spraying device 30, as hereinafter described, is conventionally known and therefore shall not be described in great detail. The description is provided to understand the general operation and mechanism for thermally applying a polymer onto a surface, according to the present invention.

In the embodiment shown, thermal spraying device 30 is a flame-spraying device, comprised of a sprayer 32 having a body portion 32a, a device hood 32b, a nozzle 32c, and a fuel control knob 32d. Sprayer 32 is connected to a fuel source that, in the embodiment shown, is comprised of a tank 34 containing propane. Valve 36 is provided to control the flow of propane to sprayer 32. Sprayer 32 is also connected to a source of pressurized air, such as an air compressor (not shown). A valve 42 is provided to control the flow of compressed air to sprayer 32. Polymer P in particulate form is mixed with aggregate A in particulate form. A mixer 52, schematically illustrated in FIG. 1, is provided for mixing polymer P and aggregate A. The mixture of polymer P and aggregate A are provided to sprayer 32 from a powder feeder 62. Powder feeder 62 is operable to meter out predetermined amounts of the particulate mixture. Compressed air is preferably used to carry the polymer particulate and aggregate A from powder feeder 62 to sprayer 32. A valve 64 is provided to control the flow of air to powder feeder 62. In the embodiment shown, powder feeder 62 is a gravity-fed injection hopper.

In the context of the present invention, thermal spraying device 30 is adapted to thermally spray polymer P and aggregate A onto a three dimensional form or structure or onto a generally planar surface. Thermal spraying device 30 is operated by “igniting” sprayer 32 by combusting the propane from tank 34 mixed with compressed air from valve 42. In another embodiment, heat sources that employ electricity to heat an air stream to a temperature sufficient to melt the thermoplastic resin may also be used. The compressed air is likewise adjusted on using valve 42 and is set to an appropriate value to produce the desired combustion flame. Powder feeder 62 is initiated to meter predetermined amounts of the mixture of polymer particulate P and aggregate A into the stream of air. The mixture of polymer powder P and aggregate A is injected axially into the combustion flame of the burning propane.

In accordance with one aspect of the present invention, polymer P with aggregate A are applied to a surface with polymer P in a softened state to enable it to adhere to the surface, but is not heated to the point where polymer P degrades. In this respect, the operating parameters of sprayer 32 are factors in controlling the temperature of polymer P particulate as applied to a surface. Another factor is the temperature of the surface itself at the time of coating. In this respect, the surface may be preheated and may also be heated by the flame from sprayer 32. The distance of sprayer 32 from the surface to be sprayed, as well as the traverse speed of sprayer 32 relative to the surface, also contribute to the amount of heating of the surface. Still further, the composition of the surface, as well as the thickness of the material to be sprayed, affects the spraying parameters. Thermal spraying of the polymer P particulate thus may involve heating of polymer particulate P by both the sprayer apparatus and the surface.

As will be appreciated by those skilled in the art, many factors affect the thermal spraying of a polymer P. Parameters relating to the actual spraying itself, such as the speed of the polymer particulate being sprayed, the flame temperature setting used in the thermal spraying, the distance of the sprayer from the surface to be sprayed, the traverse speed of the sprayer relative to the surface to be sprayed and the cooling rate of polymer P in transit and once deposited onto the surface all affect the overall polymer layer deposited on the surface. The foregoing operating parameters are preferably controlled such that polymer P particulate is heated so that the outer surface of the particulate softens to the point wherein upon impact with the surface to be coated, the particulates preferably coalesce to form a generally smooth, continuous polymer P coating.

As will further be appreciated, not only the operating characteristics of sprayer 32, but the nature of polymer P being sprayed also affects the foregoing parameters as well. As indicated above, a number of different polymers may find advantageous application in the present invention. Each type of polymer will require different operating parameters as described above. Generally, it is desirable to control the operating parameters of thermal spraying to produce a layer of coalesced polymer particles.

Generally, each type of polymer has a minimum temperature Tₘ at which it will begin to soften and will coalesce with adjacent particles when sprayed onto a surface. Thermal spraying below Tₘ will produce a grainy, sandy surface wherein the particles may rub off as a result of particles not having bonded to the surface or not having coalesced with adjacent particles. Each polymer has an upper temperature limit Tᵤ at which the particles begin to degrade producing discoloration of the sprayed polymer. Bubbling of the polymer on the sprayed surface may also occur.

The thermal spraying should take place within a temperature window defined by Tₘ and Tᵤ. Within this temperature window, the outer surface of a polymer particulate will soften sufficiently to cause it to stick to the surface and coalesce with adjoining polymer particulates to form a desired, continuous layer of polymer and aggregate.

If the polymer particulate is deposited at a temperature lower than Tₘ, the polymer coating may be post-heated with a second spray gun or a secondary heat source (e.g., infrared heater, quartz tube heater, hot air gun, oven, propane torch,) to further increase the temperature of the coating in order to promote a coalesced coating as heretofore described. The temperature of the post-heated coating would therefore be greater than Tₘ but less than Tᵤ for optimum softening and/or melting and coalescing of the polymer particulate.

The polymer chemistry and/or molecular weight of the polymer may change when thermally sprayed. These chemical changes may occur at temperatures between Tₘ and Tᵤ and, furthermore may be difficult to detect. Coatings deposited at temperatures exceeding Tᵤ are easily identified due to a discolored, oxidized, and often porous appearance.

Yet another factor affecting the resultant layer of polymer P that is sprayed is the particle size of the polymer.

In summary, the foregoing operating parameters, the distance of the sprayer from the surface of the substrate, the speed of movement of sprayer 12 relative to the surface to be coated and the overlap of subsequent paths, will affect the nature of a polymer coating applied to a surface. Ideally, the thermal spraying is conducted such that the polymer particulate coalesces on the surface and is completely flowed out.

The following operating parameters may be used to form coating 10 by a thermal spraying process using propane and air, according to the present invention:

| | |
|---|---|
| propane flow rate: | 7 to 20 liters/minute (preferably 15 liters/min.) |
| propane pressure: | 12-20 psi (preferably 14 psi) |
| air flow rate: | 120-220 liters/min. (preferably 200 liters/min.) |
| air pressure: | 60-120 psi (preferably 80 psi) |
| standoff distance: | 10-20 inches |
| gun traverse rate: | 4-20 inches/sec. (preferably 8 inches/sec.) |
| powder feed rate: | 100-400 g/minute (preferably 250 g/min.) |

In the context of the present invention, the term “polymer” is defined as including the following: a thermoplastic; engineering thermoplastic; elastomers; copolymer; block copolymer; a flame retardant polymer; a filled polymer containing either an organic or inorganic extender or filler (e.g., anti-oxidant, thermal stabilizer, UV stabilizer); a filled polymer containing a flame retardant material (either organic or inorganic); a filled polymer containing a metal, a metal alloy, a metal oxide, a pigment or another polymer and/or an elastomer that has a melt temperature higher than the host polymer, e.g., a hardened thermoset particulate, a thermoset that phase separates after application and subsequently hardens to form a hardened particulate or vulcanized rubber; an intrinsic or filled electrically conductive polymer; a liquid crystal polymer; a thermotropic liquid crystal polymer; ionomers or polymeric mixtures such as two or more thermoplastics; a combination of at least one thermoset and at least one thermoplastic; and combinations of any of the aforementioned. The term “polymer” is further defined to include, but is not limited to: polyethylene (both linear and branched), polyethylene copolymers, polypropylene, polyester, nylons, thermotropic liquid crystal polymers, ethylene-methacrylic acid copolymer, recycled plastics, ethylene methacrylic acid ionomers and the ionomer based upon polyethylene methacrylic acid, such as Surlyn® resin, sold by the DuPont Company.

By way of example and not limitation, the following are examples of thermoplastics, engineering thermoplastics and liquid crystal polymers that can be thermally sprayed as a host polymer P of the present invention.

| MATERIAL CLASS | SPECIFIC RESINS | TRADE NAMES |
|---|---|---|
| Acrylics | Polymethylmethacrylate (PMMA) | Dupont (Lucite ™) |
| Fluoroplastics | Polyethylene-tetrafluoroethylene | |
| | Copolymer P(E-TFE) | Dupont (Tefzel ™) |
| | Polyperfluoroalkoxy (PFA) | Dupont (Teflon PFA ™) |
| Ketones | Polyetheretherketone (PEEK) | ICI (Victrex ™) |
| | Polyaryletherketone (PAEK) | |
| Liquid Crystal Polymers | Thermotropic LCP’s (LCP’s) | Amoco (Xydar ™) |
| Nylon | Polyamide 6 (Nylon 6) | Dupont (Zytel ™) |
| Polyamide-imide | Polyamideimide (PAI) | Amoco (Torlon ™) |
| Polycarbonate | Polycarbonate (PC) | GE (Lexan ™) |
| Polyesters | Polyethylene Terephthalate (PET) | GE (Valox ™) |
| | Polybutylene Terephthalate (PBT) | Dupont (Crastin ™) |
| Polyetherimide | Polyetherimide (PEI) | GE (Ultem ™) |
| Polyolefins | Polyethylenes (PE, LDPE, HDPE, | Dupont (Alathon ™) |
| | UHMWPE) | Dupont (Elvax ™) |
| | Ethylene-vinylacetate Copolymers (EVA) | Dupont (Selar ™) |
| | Ethylene vinylalcohol Copolymers (EVOH) | Dow (Primacor ™) |
| | Ethylene-carboxylic acid Copolymers | Dupont (Surlyn ®) |
| | (EMAA, EAA) | Mitsubishi (Linklon ™) |
| | Ionomers (IO) | |
| | Polypropylene (PP) | |
| Polyumides | Thermoplastic Polyimide (TPPI) | Mitsui (Aurum ™) |
| Styrenes | Polystyrene (PS) | Dow Styron ™ |
| Sulfones | Polyphenylenesulfide (PPS) | GE (Supec ™) |
| Vinyls | Polyvinylchloride (PVC) | Monsanto (Opalon ™) |

By way of example and not limitation, the following are examples of elastomers (rubbers) that can be thermally sprayed.

| MATERIAL CLASS | RESIN | TRADE NAMES |
|---|---|---|
| Diene | Polyisoprene | Good Year (Natsyn ™) |
| Elastomeric Copolymers | Acrylonitrile- | Firestone (FR-N ™) |
| | Butadiene | |
| Flouroelastomers | P(VDF-HFP) | Dupont (Viton ™) |
| Thermoplastic | Polyester-based | Dupont (Hytrel ™) |
| Thermoplastic | Styrene-based | Shell (Kraton ™) |

By way of example and not limitation, the following are examples of copolymers and block copolymers that can be thermally sprayed.

| MATERIAL CLASS | RESIN | TRADE NAMES |
|---|---|---|
| Elastomeric | Acrylonitrile-Butadiene | Firestone (FR-N ™) |
| Copolymers | | |
| Fluoroplastics | Polyethylene- | Dupont (Tefzel ™) |
| | tetrafluoroethylene | |
| | Copolymer P(E-TFE) | |
| Polyolefins | Ethylene-vinylacetate | Dupont (Elvax ™) |
| | Copolymers (EVA) | Dupont (Selar ™) |
| | Ethylene vinylalcohol | Dow (Primacor ™) |
| | Copolymers (EVOH) | |
| | Ethylene-carboxylic acid | |
| | Copolymers (EMAA, EAA) | |

As indicated above, polymer P is in particulate form when thermally sprayed. Polymer P preferably has a particle size ranging from 40 to 200 microns. In one embodiment, polymer particulate diameters may range from 40 to 200 microns. In another embodiment, polymer particulate diameters may range from 90 to 140 microns, and in another embodiment may be about 100 microns in diameter.

Referring now to aggregate A, such material may consist of glass, ceramic, metal, polymer, elastomer or a combination thereof in particulate form.

Ceramic aggregate may include, but are not limited to, aluminum oxide, zirconium dioxide, titanium dioxide, garnet, mullite and carbides.

Metallic aggregate materials may include, but are not limited to, aluminum, titanium, zinc or copper.

Polymeric aggregate materials may include, but are not limited to, polymers that have a melting temperature exceeding the melting temperature of polymer P wherein aggregate materials will not melt during the thermal spraying application process. Rubber may also be used as aggregate material. In this respect, rubber or recycled tires (cross-linked rubber) in particulate form or combinations thereof, may be used as aggregate A in applications where a less abrasive, non-skid coating 10 is desired.

The particle size of aggregate A used in forming non-skid coating 10 will vary depending upon the desired physical properties of the resultant non-skid coating 10, as well as on the aggregate A used therein. In this respect, the particle size of aggregate A affects the surface profile, hardness, wear resistance, abrasion resistance and non-skid characteristics of non-skid coating 10. In accordance with the present invention, coating 10 can range from 30 microns to 1,500 microns.

The amount of aggregate A used in forming non-skid coating 10 will vary depending upon the desired physical properties of the resultant non-skid coating 10, as well as on the aggregate A used therein. The lower the amount of aggregate A in coating 10, the lower the abrasion resistance and the non-skid characteristics of coating 10 because of the relatively larger amounts of polymer P forming coating 10. Relatively large amounts of aggregate A relative to polymer P in a coating 10 may also result in lower non-skid characteristics in that few peaks and valleys may exist between adjacent aggregate particles. Further, in this respect, coating 10 with large amounts of aggregate A and low amounts of polymer P produce a coating 10 that deteriorates more rapidly.

With respect to the amount of aggregate A to be used with polymer P, it is believed that depending upon the polymer P and aggregate A used, a coating 10 formed from a mixture containing as little as 20% by weight aggregate A may find advantageous application in certain situations. In other situations, a coating containing as much as 80% by weight aggregate A may find advantageous application.

A preferable content of aggregate A in coating 10 is is 30% to 70% by weight aggregate A, the remainder of coating 10 being primarily formed of polymer P. A more preferable aggregate content in coating 10 is 40% to 60% by weight aggregate A, the remainder of coating 10 being primarily formed of polymer P.

Optionally, aramid fibers or flakes may be incorporated into the powder mixture and combined with aggregate A. Low solar absorbing additives may also be mixed with aggregate A. Furthermore, TiO₂ anatase can be incorporated into the blend for chemical self-decontaminating properties as a result of its photocatalytic properties. Generally, the final volume content of the aggregate A should be from 10-40 volume percent while the thermoplastic resin comprises the remaining fraction of the blend. Additional additives that that may be included in polymer P include UV stabilizers, flow enhancers, reduced solar absorption additives, pigments, carbon black, anti-oxidants and other additives in powder and/or particulate form.

The addition of aluminum or carbon black to such a composition also provides for anti-spark properties.

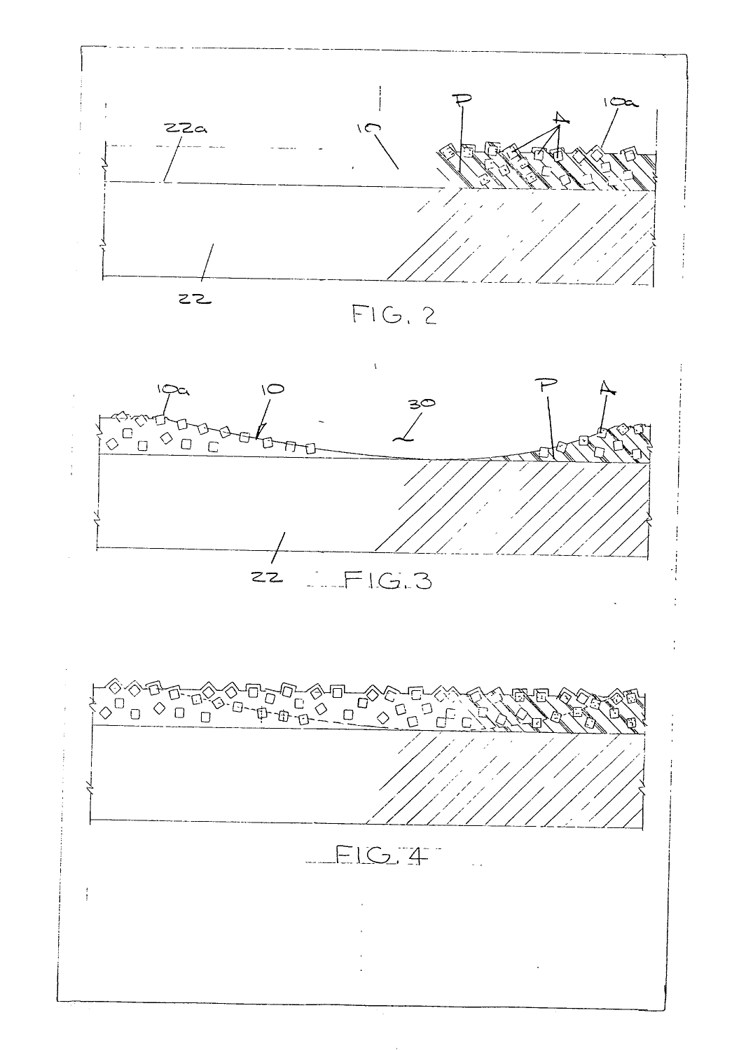

Referring now to FIG. 2, an enlarged, cross-sectional view of coating 10 is schematically illustrated. In FIG. 2, coating 10 is shown on a surface 22a of stair tread 22, shown in FIG. 1. Stair tread 22 is formed of metal and is shown for the purposes of illustration to illustrate one type of substrate on which coating 10 may be applied. As will be appreciated from a further reading of the specification, coating 10 may be applied on various substrates formed from a number of different materials. For example, substrates made of, for example, metal, wood, glass, stone, plastic and concrete surfaces, may be thermally sprayed with non-skid coating 10. Likewise, different structures made of the aforementioned materials can be thermally sprayed with non-skid coating 10 of the present invention. By way of example and not limitation, structures such as stairs, wooden deck surfaces and metallic deck surfaces may be thermally sprayed with non-skid coating 10. As indicated above, the method of the present invention provides the advantage that a non-skid coating 10 may be applied to a three dimensional structure in addition to a two dimension surface.

Prior to thermal spraying non-skid coating 10 on surface 22a, such surface is preferably cleaned. Metal surfaces, such as steel and aluminum, are preferably cleaned to be free of old coatings, rust, oxides, salts, oil, grease and other contaminants. The metal surface may be abrasive-blasted to produce a rough metal surface to enhance adhesion. The metal surface is not required to be abrasively blasted, but such blasting is recommended. Alternative surface preparation techniques include plastic media blasting, Sponge-Jet blasting™ and high pressure water jet blasting. In the event that abrasive blasting is conducted, a minimum blast of an SP 6 commercial blast is required and an SP10 near white blast is preferred. A typical anchor tooth profile of 2 to 3 mils (50 to 75 microns) provides acceptable results. Concrete surfaces may be prepared using a light abrasive blast at reduced pressure or by using a muriatic acid etchant. Fiberglass and wood surfaces can be hand-tool or power-tool cleaned to either remove the gel-coat or to produce a slightly rougher surface profile. Coating 10 can be deposited directly to the prepared surface without requiring a primer coat. Ideally, a metal deck substrate surface is heated to 175° F. to 200 ° F. prior to application. Although a preheat is not required for coating application, a preheat step tends to provide for better adhesion of the non-skid coating to the substrate. The preheat can be accomplished using the combustion spray gun or other forms of heating devices including, but not limited to, acetylene/propane torches, infrared heaters or laser.

Once the surface to be coated has been prepared and cleaned, a desired mixture of polymer P and aggregate A is thermally sprayed onto the prepared surface. As indicated above, the polymer P/aggregate A mixture is thermally sprayed such that the polymer particulate is heated so that the outer surface of the polymer particulate softens to the point wherein upon impact with the surface to be coated, the polymer particulates preferably coalesce to form a generally continuous surface coating 10. Because aggregate A is thermally sprayed with polymer P, aggregate A becomes dispersed and embedded within the coalesced polymer P, as schematically illustrated in FIG. 2. Aggregate A embedded within polymer P provides coating 10 with a rough, textured outer surface 10a . Initially, a thin layer of the particles of aggregate A near surface 10a are covered with a polymer P, as schematically illustrated in FIG. 2. In use, this thin layer of polymer P quickly wears away, exposing portions of the more abrasive, and generally harder, particles of aggregate A. The exposed portions of aggregate A provide the non-skid characteristics of coating and provide good wear resistance. As indicated above, the physical characteristics of coating 10 are a function of polymer P, aggregate A and the amounts of each used. Coating 10 may be formulated to provide a desired balance of mechanical properties, impact resistance, coefficient of friction and wear resistance. In addition, a coating 10 according to the present invention, provides good corrosion resistance to metallic substrates, such as steel and aluminum (common substrates). In this respect, the good adhesion of polymer P to the underlying substrate, retards exposure of the substrate to corrosive environmental conditions. Still further, coating 10 of the present invention is a 100% solids product with zero VOC's. There is no cure time and, thus, the coated surface is serviceable within minutes of cooling to ambient temperature. Additionally, a significant weight savings is realized since (1) the coating of the present invention does not require a primer coating; and (2) the coating of the present invention weighs about 50% to 70% less per square foot than conventional liquid-based epoxy non-skid coating formulations.

The present invention shall now be further described by way of Example, wherein a coating 10, formed according to the present invention, is described and contrasted with a conventional, non-skid, liquid-based epoxy system.

### EXAMPLE

A non-skid coating 10 according to the present invention is formed from a mixture of Surlyn® polymer resin particles (polymer P) and aluminum oxide (Al₂O₃) particles (aggregate A). Surlyn® is a registered trademark of the DuPont Company. The Surlyn® resin has an average particle size of about 120 microns. The aluminum oxide has an average particle size of about 1,035 microns. Blends containing the Surlyn® powder and aluminum oxide powder are prepared by placing equal weights of each constituent into a V-Blender and mixing the components for 30 minutes or until the aluminum oxide is uniformly distributed within the powder blend. A mixture of the Surlyn® resin particles and aluminum oxide contains about 50% by weight of aluminum oxide.

The foregoing mixture of Surlyn® resin particles and aluminum oxide particles is thermally sprayed onto a steel substrate. The mixture is applied using a propane/compressed air torch marketed by PFS Thermoplastic Coatings (KJ402). The propane pressure is set to 10-16 psi and the air pressure is set to 60-100 psi. A coating thickness of 30 to 50 mils (750 to 1,250 microns) is deposited using one pass of the spray gun by traversing the gun slowly across the substrate/deck. Multiple passes may be made to achieve the desired thickness. The deposited coating temperature is in the range of 350 to 400° F. An optimized coating temperature is determined by the temperature at which the thermoplastic resin completely flows out and appears glossy to the eye. The temperature of the mixture is maintained below the temperature at which the polymer degrades, i.e., below 550° F. for Surlyn® resin. Infrared pyrometers may be used to measure the temperature of the sprayed polymer. The combustion spray gun is preferably positioned such that the tip of the flame is in contact with the structure requiring coating, i.e., the tip of the spray gun is typically 10 to 20 inches from the surface to be coated. The thermoplastic non-skid coating 10 is overlapped 50% between passes of the spray gun in insure complete coverage. Generally, application of coating 10 is conducted in a patchwork fashion in order to deposit coating 10 onto a preheated steel surface while the steel is still at the optimum preheat temperature (about 175° F. to about 200° F.). Since there is no cure time as with conventional liquid based non-skid coatings, coating 10 can be walked upon within minutes of cooling to an ambient temperature.

Table I sets forth a list of physical properties of a coating 10 as heretofore described. Also shown are the physical properties of a conventional, non-skid, liquid-based epoxy system, MIL-W-5044C Type II, currently used by the United States military, formulated and prepared in accordance with U.S specifications.

TABLE I

| | Thermoplastic | Conventional |
|---|---|---|
| | Non-Skid | Epoxy Non-Skid |
| Friction Property | Coating 10 | Coating |
| Dry, Static Friction | 1.750 | 1.050 |
| Dry, Kinetic Friction | 1.525 | 0.925 |
| Hydraulic Oil, Static Friction | 1.000 | 0.500 |
| Hydraulic Oil, Kinetic Friction | 0.925 | 0.375 |
| After 50% Wear | 1.050 | 0.925 |
| Dry, Static Friction | 1.000 | 0.750 |
| After 50% Wear | | |
| Dry, Kinetic Friction | 0.750 | 0.450 |
| After 50% Wear | | |
| Hydraulic Oil, Static Friction | 0.625 0.375 | |
| After 50% Wear | | |
| Hydraulic Oil, Kinetic Friction | | |

Table II contrasts the abrasion rate of coating 10 and a conventional epoxy non-skid coating (MIL-W-5044C Type II). An accelerated abrasion test is performed wherein the respective surfaces are exposed to a 325 mesh diamond disc rotating at 300 RPM and under a 75 kPa load.

TABLE II

| Coating | Abrasion Rate (mg/sec) |
|---|---|
| Thermoplastic Non-skid Coating 10 | 0.210 |
| Conventional Epoxy Non-skid Coating | 0.485 |
| Arc-Sprayed Aluminum with Topcoat | 0.448 |

As is seen in the Tables, thermoplastic non-skid coating 10 has significantly higher friction under all conditions and a greater abrasion resistance than conventional non-skid, liquid-based epoxy systems currently used by the United States military.

The present invention thus provides non-skid coating 10 with high friction, good wear and corrosion resistance and coating that is environmentally benign. Furthermore, non-skid coating 10 comprised of aluminum oxide and Surlyn® resin, as heretofore described, is 2 to 10 times lighter than coating provided by a conventional liquid based epoxy non-skid system. In this respect, coating 10 according to the present invention provides considerable weight savings, for example, on a ship or aircraft carrier that may require a non-skid coating 10 over 178,000 square feet. Coating 10 according to the present invention thus provides a substantial fuel savings and return on investment over the course of the ship's lifetime.

In addition, coating 10 provides a substantial maintenance cost savings that is realized when repairing worn areas, contrasted with the costs of repairing conventional, epoxy non-skid coatings. Unlike conventional, epoxy non-skid coatings, coating 10 according to the present invention can be repaired without removal of the existing coating.

In this respect, as indicated above, repair of a conventional, epoxy non-skid coating typically requires removal of the original coating by abrasive blasting or high-pressure water spray to expose the surface to be coated. If coating 10 is damaged due to impact, wear or abrasion processes, coating 10 does not need to be blasted off for re-coating. FIG. 3 schematically illustrates a worn area 30 in coating 10. Since coating 10 contains a thermoplastic binder (polymer P), worn area 30 is simply heated to a temperature above the melting point of polymer P until surface 10a of coating 10 becomes glossy. Additional polymer P and aggregate A material is then thermally sprayed into area 30. The new material melts together with surrounding coating 10, coalescing together to produce a completely restored coating 10, as illustrated in FIG. 4, exhibiting surface friction and wear properties consistent with a newly applied, non-skid coating 10. The present invention is thus quickly repairable without extensive surface preparation.

Thus, the present invention provides a non-skid coating and a method for applying blended powders and/or particulate to produce non-skid coatings. The composition is formulated to provide the best balance of corrosion resistance, mechanical properties, impact resistance, high coefficient of friction and wear resistance. The composition provides a coating containing a thermoplastic resin filled with a dispersed, aggregate A to provide a desired surface texture.

The foregoing description is a specific embodiment of the present invention. It should be appreciated that this embodiment is described for purposes of illustration only, and that numerous alterations and modifications may be practiced by those skilled in the art without departing from the spirit and scope of the invention. It is intended that all such modifications and alterations be included insofar as they come within the scope of the invention as claimed or the equivalents thereof.

Having described the invention, the following is claimed:

1. A non-skid structure, comprised of:
a support substrate; and
a non-skid coating adhered to said substrate, said non-skid coating comprised of an aggregate material embedded in a layer comprised of at least one coalesced, thermoplastic polymer.

2. A non-skid structure as defined in claim 1, wherein said aggregate is selected from the group consisting of glass, ceramic, metal, polymer and a combination thereof.

3. A non-skid structure as defined in claim 2, wherein said aggregate has an average particle size between 30 microns and 1,500 microns.

4. A non-skid structure as defined in claim 1, wherein said aggregate comprises 35% to 65% by weight of said coating.

5. A non-skid structure as defined in claim 4, wherein said aggregate comprises 40% to 60% by weight of said coating.

6. A non-skid structure as defined in claim 4, wherein said aggregate comprises about 50% by weight of said coating.

7. A non-skid structure as defined in claim 1, wherein said aggregate comprises 10% to 40% by volume of said coating.

8. A non-skid structure as defined in claim 1, wherein said layer comprised of a plurality of coalesced thermoplastic polymers.

9. A non-skid structure as defined in claim 2, wherein said polymer is comprised of cross-linked rubber.

10. A non-skid structure as defined in claim 2, wherein said polymer is a thermosetting polymer or a thermoplastic polymer having a melting temperature greater than the melting temperature of said polymer forming said layer.

11. A method of forming a non-skid surface comprising the steps of:
mixing a thermoplastic polymer in particulate form with an aggregate in particulate form; and
thermally spraying a mixture of said polymer particulate and said aggregate onto a surface, such that said polymer particulate coalesces on said surface into a continuous layer of polymer with said aggregate embedded therein.

12. A method of forming a non-skid surface as defined in claim 11, wherein said aggregate comprises 10% to 40% by volume of said mixture.

13. A method of forming a non-skid surface as defined in claim 12, wherein said aggregate has an average particle size between 30 microns and 1,500 microns.

14. A method of forming a non-skid surface as defined in claim 13, wherein said aggregate is more wear resistant than said polymer.

15. A method of forming a non-skid surface as defined in claim 14, wherein said aggregate is selected from the group consisting of glass, ceramic, metal, polymer and a combination thereof.

16. A method of forming a non-skid surface as defined in claim 15, wherein said aggregate is a metal oxide.

17. A method of forming a non-skid surface as defined in claim 14, wherein said polymer is selected from the group consisting of polyethylene, polyethylene copolymers, polypropylene, polyester, nylons, thermotropic liquid crystal polymers, ethylene-methacrylic acid copolymers, ethylene methacrylic acid ionomers, recycled plastic and combinations thereof.

18. A non-skid coating, comprised of an aggregate material embedded within a layer comprised of at least one coalesced, thermoplastic polymer, said aggregate having a melting temperature greater than the melting temperature of said at least one coalesced, thermoplastic polymer, and said coating containing no volatile, organic compounds.

19. A non-skid coating as defined in claim 18, wherein said aggregate is selected from the group consisting of glass, ceramic, metal, polymer and a combination thereof.

20. A non-skid coating as defined in claim 19, wherein said aggregate has an average particle size between 30 microns and 1,500 microns.

21. A non-skid coating as defined in claim 18, wherein said aggregate comprises 35% to 65% by weight of said coating.

22. A non-skid coating as defined in claim 21, wherein said aggregate comprises 40% to 60% by weight of said coating.

23. A non-skid coating as defined in claim 18, wherein said coating is thermally sprayed.

24. A method of repairing a non-skid coating comprised of an aggregate embedded in a layer comprised of at least one thermoplastic polymer, comprising the steps of:
heating said non-skid coating until the outer surface thereof begins to melt; and
thermally spraying a mixture of said aggregate and a polymer containing said at least one thermoplastic polymer onto said outer surface of said coating.

25. A coating mix for forming a non-skid coating by a thermal spraying process having a polymer powder comprised of at least one thermoplastic polymer powder, and an aggregate powder, said aggregate powder formed from a material selected from the group consisting of glass, ceramic, metal, polymer, elastomer and combinations thereof, said coating mix containing no volatile organic compounds.

26. A coating mix as defined in claim 25, wherein said aggregate powder comprises 30% to 70% by weight of said coating mix.

27. A coating mix as defined in claim 26, wherein said aggregate powder is ceramic.

28. A coating mix as defined in claim 27, wherein said aggregate powder comprises 40% to 60% by weight of said coating mix.

29. A coating mix as defined in claim 25, wherein said aggregate powder has a melting temperature greater than the melting temperature of said polymer powder.
